(19) United States
(12) Patent Application Publication
(10) Pub. No.: US 2025/0018292 A1
(43) Pub. Date: Jan. 16, 2025

(54) PROGRAM, INFORMATION PROCESSING DEVICE, INFORMATION PROCESSING METHOD, AND GAME ASSISTING METHOD

(71) Applicant: CYGAMES, INC., Tokyo (JP)

(72) Inventors: Yuito Kimura, Tokyo (JP); Takatoshi Nakamura, Tokyo (JP); Kento Inoue, Tokyo (JP); Yuki Takano, Tokyo (JP); Christophe Sadoine, Tokyo (JP); Mitsuru Hasegawa, Tokyo (JP); Junya Kumada, Tokyo (JP)

(73) Assignee: CYGAMES, INC., Tokyo (JP)

(21) Appl. No.: 18/900,026

(22) Filed: Sep. 27, 2024

Related U.S. Application Data
(63) Continuation of application No. PCT/JP2023/011910, filed on Mar. 24, 2023.

(30) Foreign Application Priority Data
Mar. 30, 2022 (JP) 2022-057761

(51) Int. Cl. A63F 13/537; A63F 13/54; A63F 13/58

(52) U.S. Cl. CPC A63F 13/537; A63F 13/54; A63F 13/58

(57) ABSTRACT

A method may include setting, on the basis of an input by a player, a type of character among various types of characters as the character linked to the player. The method further includes commanding a display unit to display a progress indicator corresponding to the progress of a game. The method further includes accepting an input, by a player, corresponding to the progress indicator. The method further includes commanding a sound output unit to output narration voice that corresponds to the character set as linked to the player and that is related to the progress of the game.

### CROSS-REFERENCE TO RELATED APPLICATIONS

This application is a continuation of International Patent Application No. PCT/JP2023/011910, having an international filing date of Mar. 24, 2023, which designated the United States, the entirety of which is incorporated herein by reference. Japanese Patent Application No. 2022-057761 filed on Mar. 30, 2022 is also incorporated herein by reference in its entirety.

### BACKGROUND OF THE INVENTION

The present invention relates to a program, an information processing device, an information processing method, and a game assisting method.

It is known that games, such as card games and board games, in which players play a battle against each other using real game media are played virtually by using information processing devices such as smart phones. For example, in a virtual card game, the game proceeds as card images are displayed and game parameters are automatically calculated and displayed while image effects are displayed and sound effects are output with the progress of the game (see Japanese Patent No. 6739607).

When players play a battle game face-to-face by using real game media, the players can have fun playing the game while verbally communicating with each other; however, in the instances where verbal communication is not advisable, such as during epidemics, the players would be less eager to play face-to-face the battle game that uses real game media.

### SUMMARY OF THE INVENTION

The present invention has been made under the aforementioned circumstances, and an object thereof is to provide a program, an information processing device, an information processing method, and a game assisting method that improve the excitement of the battle game played by using real game media.

According to a first aspect of the disclosure, there is provided a program for assisting a game in which players play a battle against each other using real game media, the program instructing a computer to function as:
a display control unit that commands a display unit to display a progress indicator corresponding to the progress of the game,
an input accepting unit that accepts an input, by a player, corresponding to the progress indicator,
a sound control unit that commands a sound output unit to output narration voice related to the progress of the game when the input, by the player, corresponding to the progress indicator is accepted, and
a setting unit that sets, on the basis of the input by the player, one of a plurality of types of characters as the character linked to the player,
wherein the sound control unit
commands the sound output unit to output the narration voice corresponding to the character set as linked to the player.

According to a second aspect of the disclosure, there is provided a program for assisting a game in which players play a battle against each other using real game media, the program instructing a computer to function as:
a display control unit that commands a display unit to display a plurality of types of emotion indicators corresponding to a plurality of types of emotional expression,
an input accepting unit that accepts an input, by a player, corresponding to one of the plurality of types of emotion indicators, and
a sound control unit that commands a sound output unit to output voice of the emotional expression corresponding to the emotion indicator input by the player when the input, by the player, corresponding to one of the plurality of types of emotion indicators is accepted.

According to a third aspect of the disclosure, there is provided an information processing device that assists a game in which players play a battle against each other using real game media, the information processing device comprising:
a display control unit that commands a display unit to display a progress indicator corresponding to the progress of the game;
an input accepting unit that accepts an input, by a player, corresponding to the progress indicator;
a sound control unit that commands a sound output unit to output narration voice related to the progress of the game when the input, by the player, corresponding to the progress indicator is accepted; and
a setting unit that sets, on the basis of the input by the player, one of a plurality of types of characters as the character linked to the player,
wherein the sound control unit
   commands the sound output unit to output the narration voice corresponding to the character set as linked to the player.

According to a fourth aspect of the disclosure, there is provided an information processing method for assisting a game in which players play a battle against each other using real game media, the information processing method executable by a computer and comprising:
setting, on the basis of an input by a player, one of a plurality of types of characters as the character linked to the player;
commanding a display unit to display a progress indicator corresponding to the progress of the game;
accepting an input, by a player, corresponding to the progress indicator; and
commanding a sound output unit to output narration voice that corresponds to the character set as linked to the player and that is related to the progress of the game.

According to a fifth aspect of the disclosure, there is provided an information processing device that assists a game in which players play a battle against each other using real game media, the information processing device comprising:
a display control unit that commands a display unit to display a plurality of types of emotion indicators corresponding to a plurality of types of emotional expression;
an input accepting unit that accepts an input, by a player, corresponding to one of the plurality of types of emotion indicators, and
a sound control unit that commands a sound output unit to output voice of the emotional expression corresponding to the emotion indicator input by the player when the input, by the player, corresponding to one of the plurality of types of emotion indicators is accepted.

According to a sixth aspect of the disclosure, there is provided an information processing method for assisting a game in which players play a battle against each other using real game media, the information processing method executable by a computer and comprising:
commanding a display unit to display a plurality of types of emotion indicators corresponding to a plurality of types of emotional expression;
accepting an input, by a player, corresponding to one of the plurality of types of emotion indicators; and
commanding a sound output unit to output voice of the emotional expression corresponding to the emotion indicator input by the player when the input, by the player, corresponding to one of the plurality of types of emotion indicators is accepted.

### BRIEF DESCRIPTION OF DRAWINGS

FIG. 1 is a schematic block diagram illustrating the structure of an information processing system according to an embodiment of the present invention.

FIG. 2 is a functional block diagram illustrating functions of a server device according to an embodiment of the present invention.

FIG. 3 is a functional block diagram illustrating functions of a terminal device according to an embodiment of the present invention.

FIG. 4 is a diagram illustrating examples of cards according to an embodiment of the present invention.

FIG. 5 is a diagram illustrating the procedure of a card game according to an embodiment of the present invention.

FIG. 6 is a diagram illustrating an image displayed in a display area of a terminal device according to an embodiment of the present invention.

FIG. 7 is a diagram illustrating an image displayed in the display area of the terminal device according to an embodiment of the present invention.

FIG. 8 is a diagram illustrating an image displayed in the display area of the terminal device according to an embodiment of the present invention.

FIG. 9 is a diagram illustrating an image displayed in the display area of the terminal device according to an embodiment of the present invention.

FIG. 10 is a diagram illustrating an image displayed in the display area of the terminal device according to an embodiment of the present invention.

FIG. 11 illustrates tables describing voice data according to an embodiment of the present invention.

FIG. 12 is a diagram illustrating an image displayed in the display area of the terminal device according to an embodiment of the present invention.

FIG. 13 is a diagram illustrating an image displayed in the display area of the terminal device according to an embodiment of the present invention.

FIG. 14 is a diagram illustrating an image displayed in the display area of the terminal device according to an embodiment of the present invention.

FIG. 15 is a flowchart illustrating a process executed in the terminal device according to an embodiment of the present invention.

FIG. 16 is a flowchart illustrating a process executed in the terminal device according to an embodiment of the present invention.

FIG. 17 is a flowchart illustrating a process executed in the terminal device according to an embodiment of the present invention.

### DETAILED DESCRIPTION OF THE INVENTION

(1) The present embodiment relates to a program for assisting a game in which players play a battle against each other using real game media, the program instructing a computer to function as: a display control unit that commands a display unit to display a progress indicator corresponding to the progress of the game, an input accepting unit that accepts an input, by a player, corresponding to the progress indicator, and a sound control unit that commands a sound output unit to output narration voice related to the progress of the game when the input, by the player, corresponding to the progress indicator is accepted.

According to the present embodiment, since the sound output unit outputs the narration voice related to the progress of the game when the input, by the player, corresponding to the progress indicator is accepted, the game can smoothly progress without verbal communication.
(2) Furthermore, in the present embodiment, the computer may be further instructed to function as a setting unit that sets, on the basis of the input by the player, one of multiple types of characters as the character linked to the player, and the sound control unit may command the sound output unit to output the narration voice corresponding to the character set as linked to the player.

In this manner, since the sound output unit outputs narration voice corresponding to the character selected by the player, the game can smoothly progress and provide enjoyment without verbal communication.
(3) Furthermore, in the present embodiment, the computer may be further instructed to function as a specific information acquisition unit that acquires specific information corresponding to the real game media, and the sound control unit may command the sound output unit to output the narration voice corresponding to the acquired specific information.

In this manner, since the sound output unit outputs the narration voice corresponding to the real game media, the game can smoothly progress and provide enjoyment without verbal communication, and the motivation for acquiring the real game media can be improved.
(4) Furthermore, in the present embodiment, the display control unit may command the display unit to display multiple types of emotion indicators corresponding to multiple types of emotional expression, the input accepting unit may accept an input, by a player, corresponding to one of the multiple types of emotion indicators, and, when the input, by the player, corresponding to one of the multiple types of emotion indicators is accepted, the sound control unit may command the sound output unit to output voice of emotional expression corresponding to the emotion indicator input by the player.

In this manner, since the sound output unit can output the voice of multiple types of emotional expression according to the player's input, the game can smoothly proceed and provide enjoyment without verbal communication.
(5) Furthermore, in the present embodiment, the display control unit may command the display unit to display a parameter indicator indicating a parameter of the game and may cause the parameter indicator to change on the basis of an input by a player.

In this manner, the game can smoothly proceed and provide enjoyment without verbal communication while alleviating the burden of players to administer various parameters.
(6) The present embodiment also relates to an information processing device that assists a game in which players play a battle against each other using real game media, the information processing device including: a display control unit that commands a display unit to display a progress indicator corresponding to the progress of the game; an input accepting unit that accepts an input, by a player, corresponding to the progress indicator; and a sound control unit that commands a sound output unit to output narration voice related to the progress of the game when the input, by the player, corresponding to the progress indicator is accepted.
(7) The present embodiment also relates to an information processing method for assisting a game in which players play a battle against each other using real game media, the information processing method executable by a computer and including: commanding a display unit to display a progress indicator corresponding to the progress of the game; accepting an input, by a player, corresponding to the progress indicator; and commanding a sound output unit to output narration voice related to the progress of the game when the input, by the player, corresponding to the progress indicator is accepted.
(8) The present embodiment also relates to a method for assisting a game in which players play a battle against each other using real game media in alternating turns, the method including a step of allowing a display unit to display a specific indicator corresponding to turn alternation between the players, a step of accepting an input by the player corresponding to the specific indicator, and a step of allowing a sound output unit to output specific voice corresponding to the turn alternation when the input, by the player, corresponding to the specific indicator is accepted.
(9) The present embodiment also relates to a non-transitory computer-readable information storage medium that stores a program for assisting a game in which players play a battle against each other using real game media, the program instructing a computer to function as a display control unit that commands a display unit to display a progress indicator corresponding to the progress of the game, an input accepting unit that accepts an input, by a player, corresponding to the progress indicator, and a sound control unit that commands a sound output unit to output narration voice related to the progress of the game when the input, by the player, corresponding to the progress indicator is accepted.

Embodiments of the present invention will now be described. Note that the embodiments described below do not unreasonably limit the features of the present invention recited in the claims. Furthermore, not all of the features described in the embodiments are necessarily essential constituent features of the present invention.

### 1. Configuration of Information Processing System

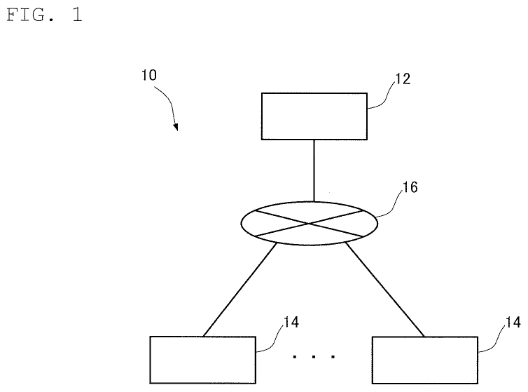

FIG. 1 is a schematic block diagram illustrating the configuration of an information processing system 10 according to an embodiment. As illustrated in FIG. 1, the information processing system 10 includes a server device 12 (information processing device) and multiple terminal devices 14 (information processing device) that are connected via a network 16 such as the Internet, a mobile telephone network, a LAN, or a WAN, and therefore constitutes a what is known as client-server communication system. Each of the terminal devices 14 exchanges various types of information through communication with the server device 12 via the network 16, and exchanges various types of information through communication with other terminal devices 14 via the network 16 and the server device 12.

The server device 12 is equipped with a processor such as a CPU, a main storage device such as a ROM or a RAM, an external storage device such as a hard disk, an input device such as a keyboard, a display device such as a liquid crystal display, a communication device, etc. In the server device 12, a CPU executes various processes according to a program stored in the main storage device or a program loaded onto the main storage device from the external storage device to receive information from the terminal devices 14 through the communication device and send information to the terminal devices 14.

Each of the terminal devices 14 can be various forms of information processing devices, such as a smart phone, a tablet, a personal computer, a mobile gaming machine, or a stationary gaming machine installed in stores and homes, and each of the terminal devices 14 is also equipped with a processor such as a CPU, a main storage device such as a ROM or a RAM, an external storage device such as a flash memory and a hard disk, an input device such as a touch panel, a keyboard, and a microphone, a display device such as a liquid crystal display and an organic EL display, a sound output device such as speakers, a communication device, etc. In the terminal devices 14 also, the CPU executes various processes according to a program stored in the main storage device or a program loaded onto the main storage device from the external storage device to receive information from the server device 12 through the communication device and send information to the server device 12 and other terminal devices 14.

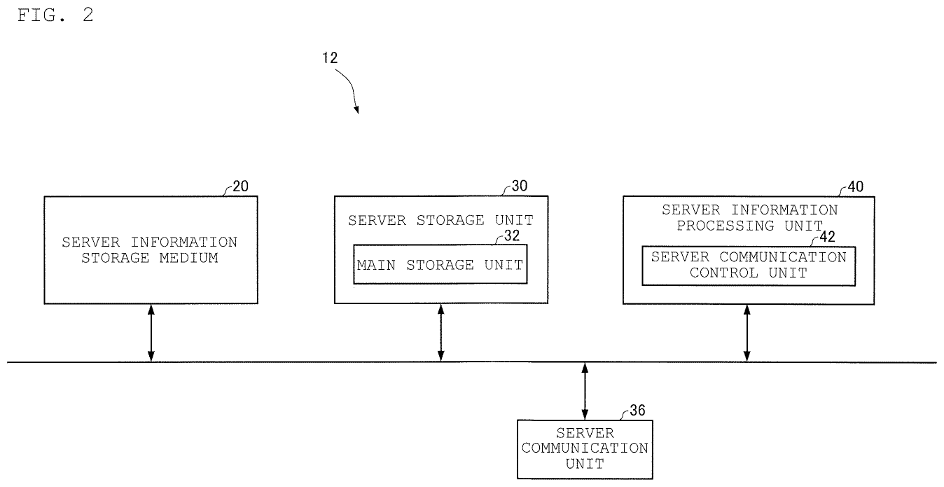

FIG. 2 is a functional block diagram illustrating functions of the server device 12 according to this embodiment. As illustrated in FIG. 2, the server device 12 according to this embodiment includes a server information storage medium 20, a server storage unit 30, a server communication unit 36, and a server information processing unit 40. Note that some of the components (units) illustrated in FIG. 2 may be omitted.

The server information storage medium 20 stores programs, data, etc., needed for the server information processing unit 40 and the server communication unit 36 to perform various processes, and stores programs and data to be downloaded to the terminal devices 14. The functions of the server information storage medium 20 can be realized through a flash memory, a hard disk, an optical disk (DVD or BD), etc. That is, the server information storage medium 20 stores programs (program instructing a computer to execute processes of the units) needed for the computer to function as the units of the present embodiment.

The server storage unit 30 serves as a work area for the server information processing unit 40 and the server communication unit 36, and the function thereof can be realized through a RAM (main memory), a VRAM (video memory), etc. Specifically, the server storage unit 30 includes a main storage unit 32 into which programs and data from the server information storage medium 20 are loaded.

The server communication unit 36 performs various controls needed to communicate with an external network (for example, another server device 12 or a terminal device 14), and the functions thereof can be realized through various processors (CPU (main processor), DSP, etc.) or hardware such as communication ASICs, programs, etc.

The server information processing unit 40 performs various processes on the basis of the received data received by the server communication unit 36, the results of various processes performed in the server information processing unit 40, programs and data loaded into the main storage unit 32, etc., and the functions thereof can be realized through various processors, hardware such as ASICs, and programs. In addition, the server information processing unit 40 includes a server communication control unit 42.

The server communication control unit 42 performs a process of commanding the server communication unit 36 to communicate with another server device 12 or terminal device 14 to exchange various information. For example, the server communication control unit 42 performs processes for receiving, from a terminal device 14, a request to download a program or data and for sending the program or data to the terminal device 14 that requested the download.

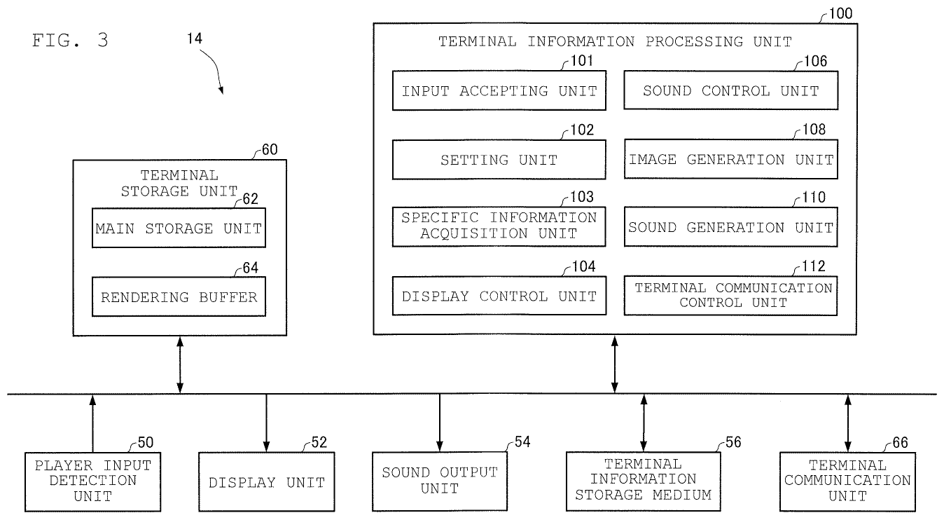

FIG. 3 is a functional block diagram illustrating functions of the terminal device 14 according to this embodiment. As illustrated in FIG. 3, the terminal device 14 of this embodiment includes a player input detection unit 50, a display unit 52, a sound output unit 54, a terminal information storage medium 56, a terminal storage unit 60, a terminal communication unit 66, and a terminal information processing unit 100. Note that some of the components (units) illustrated in FIG. 3 may be omitted.

The player input detection unit 50 is for detecting, as a player's input, an input made by the player onto the terminal device 14, and the function thereof can be realized through a touch sensor, a switch, an optical sensor, a microphone, or the like.

The display unit 52 is for displaying images on a display screen, and the function thereof can be realized through a liquid crystal display, an organic EL display, or the like.

The sound output unit 54 is for outputting sound, and the function thereof can be realized through a speaker, a headphone, or the like.

The terminal information storage medium 56 is for storing programs, data, etc., needed for the terminal information processing unit 100 and the terminal communication unit 66 to perform various processes, and the function thereof can be realized through a flash memory, a hard disk, an optical disk (DVD or BD), or the like. In other words, the terminal information storage medium 56 stores programs (program instructing a computer to execute processes of the units) needed for the computer to function as the units of the present embodiment.

The terminal storage unit 60 serves as a work area for the terminal information processing unit 100 and the terminal communication unit 66, and the function thereof can be realized through a RAM (main memory), a VRAM (video memory), or the like. Specifically, the terminal storage unit 60 includes a main storage unit 62 into which programs and data from the terminal information storage medium 56 are loaded, and a rendering buffer 64 in which images to be displayed on the display unit 52 are rendered.

The terminal communication unit 66 is for performing various controls needed to communicate with an external network (for example, the server device 12 or another terminal device 14), and the function thereof can be realized through hardware such as various processors or communication ASICs, programs, etc.

Furthermore, the terminal communication unit 66 performs various controls needed for short-distance wireless communication with tags and chips, and the function thereof can be realized through a radio frequency identifier (RFID) reader, a near-field communication (NFC) reader, or the like.

The programs (data) for instructing a computer to function as individual units of the present embodiment may be downloaded from the server device 12 to the terminal information storage medium 56 (or the main storage unit 62) of the terminal device 14 via the network 16 and the terminal communication unit 66, and such use of the server device 12 can also be included in the scope of the present invention.

The terminal information processing unit 100 performs various processes, such as a game process, an image generation process, and a sound generation process, by using the main storage unit 62 as the work area on the basis of the player's input detected by the player input detection unit 50, the received data received by the terminal communication unit 66, and various programs and data in the terminal storage unit 60, and the function thereof can be realized through hardware such as various processors (CPU (main processor), GPU (rendering processor), DSP, etc.) or ASICs, and programs.

The terminal information processing unit 100 includes an input accepting unit 101, a setting unit 102, a specific information acquisition unit 103, a display control unit 104, a sound control unit 106, an image generation unit 108, a sound generation unit 110, and a terminal communication control unit 112. Note that some of these units may be omitted.

On the basis of the player's input detected by the player input detection unit 50 and the program, data, etc., loaded into the main storage unit 62, the input accepting unit 101 accepts the player's input as a situation-dependent type of player's input and sets the player's input in an enabled state or a disabled state depending on the situation. For example, when a GUI, such as a button, is tapped in a state where the GUI is being displayed, a process of accepting the input as an input corresponding to the type of the displayed GUI is performed, or a process of rejecting the validity of the input despite tapping of the GUI is performed.

On the basis of the player's input accepted by the input accepting unit 101, the received data received by the terminal communication unit 66, the results of various processes executed in the terminal information processing unit 100, the programs and data loaded into the main storage unit 62, etc., the setting unit 102 sets one of multiple types of classes as the class linked to that player or sets one of multiple characters as the character linked to that player.

For example, the setting unit 102 may be designed such that, when one of the multiple types of classes is set to be linked to the player on the basis of the player's input, a character corresponding to that class may be automatically set as the character linked to the player, or such that, when one of the multiple characters is set as a character linked to that player on the basis of the player's input, the class corresponding to that character may be automatically set as the class linked to that player.

On the basis of the player's input accepted by the input accepting unit 101, the received data received by the terminal communication unit 66, the results of various processes executed in the terminal information processing unit 100, the programs and data loaded into the main storage unit 62, etc., the specific information acquisition unit 103 acquires specific information that has been read out from tags and chips by an RFID reader or NFC reader that performs short-distance wireless communication in the terminal communication unit 66.

The display control unit 104 performs display control of images to be displayed on the display unit 52. In particular, on the basis of the player's input accepted by the input accepting unit 101, the specific information acquired by the specific information acquisition unit 103, the received data received by the terminal communication unit 66, the results of various processes executed in the terminal information processing unit 100, the programs and data loaded into the main storage unit 62, etc., display control is performed on the display content, display mode, and display timing of various objects and prerendered images (movie images), etc.

In this embodiment, the terminal information storage medium 56 stores object data of various objects such as character objects for displaying characters, background objects for displaying the background, effect objects for displaying effects, and graphic user interface (GUI) objects for displaying GUIs such as buttons, and image data of various prerendered images. Then the display control unit 104 performs display control on the objects and prerendered images on the basis of the object data and the image data of the prerendered images loaded into the main storage unit 62.

The sound control unit 106 controls the sound to be output from the sound output unit 54. In particular, on the basis of the player's input accepted by the input accepting unit 101, the specific information acquired by the specific information acquisition unit 103, the received data received by the terminal communication unit 66, the results of various processes executed in the terminal information processing unit 100, the programs and data loaded into the main storage unit 62, etc., the content, mode, and output timing of the sound to be output are controlled.

In this embodiment, various types of sound data including voice data for outputting lines to be spoken by characters, sound effect data, and music data are stored in the terminal information storage medium 56. The sound control unit 106 performs controls to allow the sound output unit 54 to output various types of sound on the basis of the sound data loaded into the main storage unit 62.

On the basis of the player's input accepted by the input accepting unit 101, the received data received by the terminal communication unit 66, the results of various processes executed in the terminal information processing unit 100, in particular, the results of various processes executed in the display control unit 104, the programs and data loaded into the main storage unit 62, etc., the image generation unit 108 performs a process of rendering a game image in the rendering buffer 64 frame-by-frame so as to generate game images in which various objects and various prerendered images are displayed, and outputs the generated game images to the display unit 52 so that the display unit 52 displays the game images.

The sound generation unit 110 performs a sound process on the basis of the results of various processes executed in the sound control unit 106 so as to generate game sound such as BGM, sound effect, and voice, and outputs the generated game sound to the sound output unit 54.

The terminal communication control unit 112 performs a process for allowing the terminal communication unit 66 to communicate with the server device 12 and other terminal devices 14 to exchange various types of information. For example, the terminal communication control unit 112 commands the terminal communication unit 66 to send and receive information necessary for a process of newly registering a player in the information processing system 10, information necessary for a process of allowing the player to login to the information processing system 10, etc. Furthermore, the terminal communication control unit 112 commands the terminal communication unit 66 to send and receive address information indicating where to the information is headed, sender information indicating the sender of the information, identification information that identifies the information processing system 10 that has generated the information, etc.

It should be noted that all or some of the functions of the terminal information storage medium 56 of the terminal devices 14, all or some of the functions of the terminal storage unit 60, all or some of the functions of the terminal game processing unit 102, all or some of the functions of the display control unit 104, or some of the functions of the image generation unit 108 may be assigned to the server device 12; and all or some of the functions of the server information storage medium 20 of the server device 12, all or some of the functions of the server storage unit 30, and all or some of the functions of the server game processing unit 41 may be assigned to the terminal devices 14.

### 2. Method of the Present Embodiment

In the description below, the method of the present embodiment is described in detail by using an example in which a program for assisting a card game in which two players play a battle using real cards (game media) is applied to application software of a smart phone (terminal device 14).

The card game of this embodiment is what is known as a trading card game (TGC) or a collectible card game (CCG), in which players each build a deck (game medium group) by selecting 40 to 50 cards from cards in player's possession and battle each other by drawing cards included in the built deck to add to the hand and placing cards onto the field from the hand in alternating turns.

Specifically, the cards of the present embodiment include class-assigned cards each belonging to one of six types of classes, A to F, and common-class cards that do not belong to any of the classes, and each player builds a deck by class-assigned cards that belong to the class selected by the player and common-class cards. Here, a deck may or may not include multiple cards of the same type.

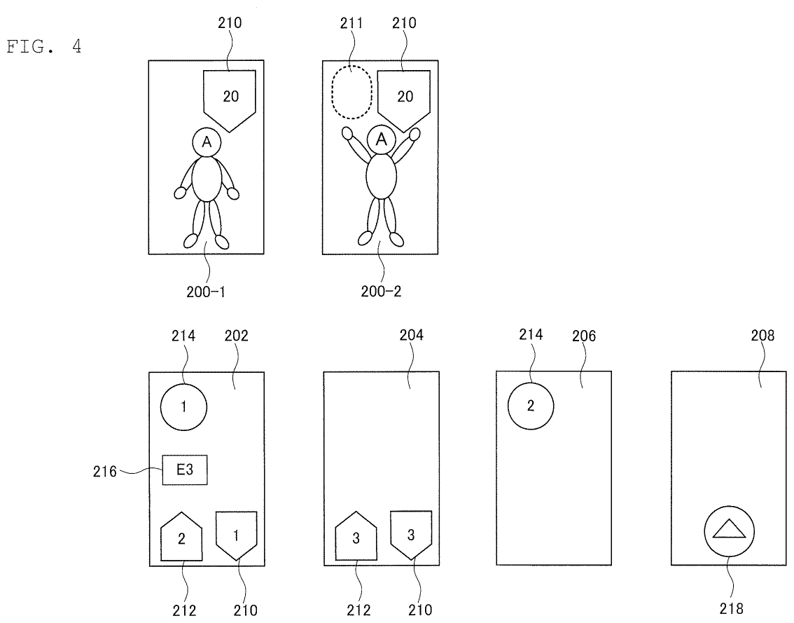

FIG. 4 is a diagram illustrating examples of cards used in this embodiment. As illustrated in FIG. 4, the cards of this embodiment include leader cards 200, a follower card 202, an evolution card 204, a spell card 206, and an amulet card 208.

A leader card 200 indicates a leader character of one class, and there is a leader card 200 for each of Class A to Class F. A leader card 200 of each class indicates the name and picture of the leader character of each class and an initial physical strength indicator 210 that indicates the initial physical strength (parameter) of that card.

There are a normal leader card 200-1 and a special leader card 200-2 as the leader cards 200 for each class. A normal leader card 200-1 is a card included in a starter pack sold as a bundle of cards necessary for starting the card game of this embodiment whereas a special leader card 200-2 is a card not included in the starter pack and is a so-called rare card that may be included at a low probability in an additional pack of randomly selected eight cards sold with content thereof unrevealed.

A normal leader card 200-1 and a special leader card 200-2 indicate the name of the same leader character, different pictures of that same leader character, and the same initial physical strength indicator 210.

In the example illustrated in FIG. 4, a Class-A normal leader card 200-1 indicates the name of Character A, a picture of Character A standing with both hands down, and the initial physical strength indicator 210 indicating 20, and a Class-A special leader card 200-2 indicates the name of Character A, a picture of Character A standing with both hands up, and the initial physical strength indicator 210 indicating 20.

A special leader card 200-2 of each class is equipped with an NFC tag 211, and when a smart phone is placed near the special leader card 200-2 of each class, the NFC reader in the smart phone can read identification information (specific information) of the special leader card 200-2 stored in the NFC tag 211.

The leader character of each class is specified as a normal leader character until the identification information of the special leader card 200-2 of the corresponding class is read, and once the identification information of the special leader card 200-2 of the corresponding class is read, the leader character is specified as a special leader character

A follower card 202 is a card that can attack the opponent's leader card 200 when placed in the field, and there are class-assigned follower cards 202 and common-class follower cards 202. Each follower card 202 indicates the name and picture of a follower, the initial physical strength indicator 210, an attack power indicator 212 indicating the attack power (parameter) of that card, and a play cost indicator 214 that indicates the play cost (parameter) necessary for placing that card onto the field.

Furthermore, follower cards 202 include evolvable follower cards 202 and non-evolvable follower cards 202, and an evolvable follower card 202 indicates an evolution cost indicator 216 that indicates the evolution cost (parameter) necessary for evolving that card.

An evolution card 204 is a card that is placed onto the field when evolution conditions are satisfied while an evolvable follower card 202 is on the field, and there are evolution cards 204 for the class-assigned follower cards 202 and evolution cards 204 for the common-class follower cards 202. Each evolution card 204 indicates the name and picture of the follower after evolution, the initial physical strength indicator 210, and the attack power indicator 212 but not the play cost indicator 214 since the play cost is not necessary. Here, the initial physical strength or the attack power of each of the evolution cards 204 is higher than the initial physical strength or the attack power of the follower card 202 before evolution.

A spell card 206 is a card that exerts an effect as soon as the card is placed on the field and is then removed from the field, and there are class-assigned spell cards 206 and common-class spell cards 206. Each spell card 206 indicates the name and picture of the spell and the play cost indicator 214 but not the initial physical strength indicator 210 and the attack power indicator 212 since the spell card 206 cannot be attacked from other cards and does not attack other cards.

An amulet card 208 is a card that exerts an effect when predetermined effect-generating conditions are met while the card is on the field and that is removed from the field when the predetermined removal conditions are met, and there are class-assigned amulet cards 208 and common-class amulet cards 208. Each amulet card 208 indicates the name and picture of the amulet and an effect indicator 218 that indicates the effect of the card, but not the initial physical strength indicator 210, the attack power indicator 212, or the play cost indicator 214 since the amulet card 208 cannot be attacked from other cards, does not attack other cards, and does not require a play cost.

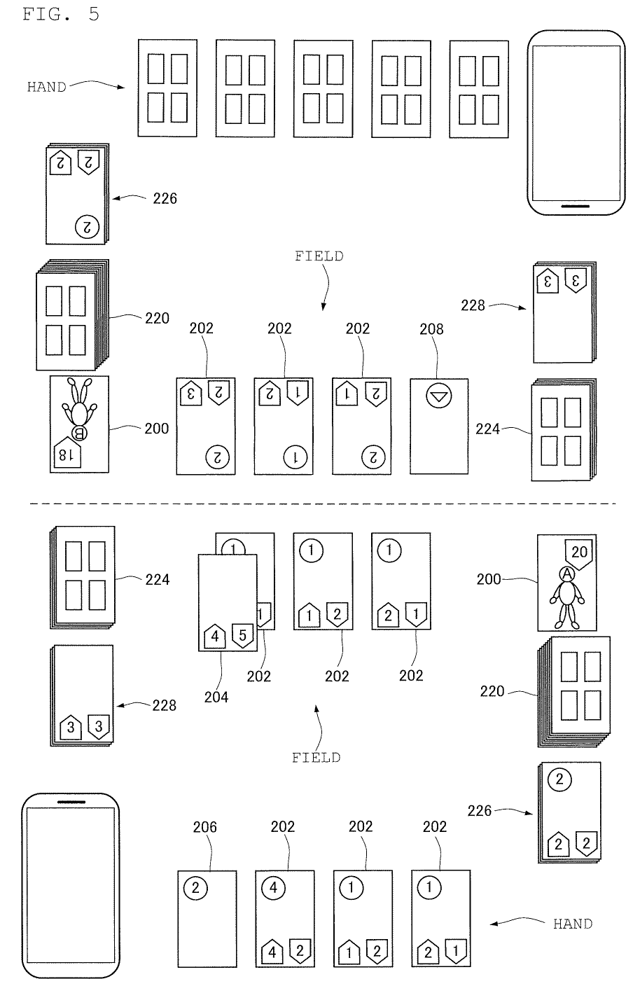

FIG. 5 is a diagram for explaining the procedure of the card game according to this embodiment. In FIG. 5, cards of the user player are placed in the lower half and cards of the opponent facing the user player are placed in the upper half. A face-up leader card 200 of the class selected by each player is placed on the right side of the field of each player, and a face-down main deck 220 of each player is placed on the side of the leader card 200 close to the player. In the example illustrated in FIG. 5, a Class-A leader card 200 is placed as the leader card 200 of the user player, and a Class-B leader card 200 is placed as the leader card 200 of the opponent.

When each player builds a main deck 220, the player builds an evolution deck 224 by using evolution cards 204 corresponding to the evolvable follower cards 202 included in the player's main deck 220. The evolution deck 224 is placed face-down on the left side of each player's field. Note that, in this embodiment, the evolution deck 224 can include up to ten evolution cards 204.

Then the players decide who plays first and who plays second, and each draw at random three cards (a predetermined number of cards) from the player's own shuffled main deck 220 without the knowledge of the contents of the cards so as to create an initial hand. Here, each player can redraw all or some of the three cards in the initial hand just once.

Each player holds the hand so that the content of the hand is revealed to the user player but not to the opponent. After each of the players decides on the initial hand, a first turn of the first player arrives, and the first player draws one card from the player's own main deck 220 to add to the hand.

The turn player can place cards onto the field from the hand; however, a card for which a play cost is indicated can only be placed in the field within the play points (parameter) given to the turn player every time the turn alternates.

When a card with a play cost indicated therein is placed on the field, the play cost indicated in the card placed on the field is subtracted from the play points, and when the play points reach 0, a card with a play cost indicated therein can no longer be placed on the field in this turn.

In this embodiment, first, 1 point is given, as the initial play points of the first turn, to the first player, and then 1 point is given, as the initial play points of the first turn, to the second player; then 2 points are given, as the initial play points of the second turn, to the first player, and 2 points are given, as the initial play points of the second turn, to the second player. As such, the same initial play points are given to the first player and the second player every time the turn arrives, and the initial play points given on each turn increase by 1 point every time the turn arrives. Here, the remaining play points not consumed in one turn are not carried over to the next turn.

Furthermore, the maximum initial play points given on one turn are 10 points. After 10 points are given as the initial play points to each of the first player and the second player on their 10th turns, 10 points are given as the initial play points on the 11th and subsequent turns.

Accordingly, on the first turn, since the initial play points given are 1 point for both the first player and the second player, placing one card with a play cost of 1 onto the field brings the play points to 0, and cards with play costs indicated therein can no longer be placed on the field. However, cards with no play cost indicated therein, that is, cards with a play cost of 0, can be placed on the field without consuming play points and thus such cards can be placed on the field even when the play points are 0.

Here, the upper limit of the number of cards placed on the field is set to 5 for each player, and thus a player that already has placed five cards on the field cannot place additional cards on the field unless the number of cards on the field decreases to 4 or less.

When the first player ends the first turn, a first turn of the second player arrives, and the second player draws two cards from the player's own main deck 220 to add to the hand. On the second and subsequent turns, each player draws one card from its own main deck 220 to add to the hand. In other words, in this embodiment, there is an advantageous element for the first player, and thus the number of cards the second player adds to the hand on the first turn is set to 2 only in the first turn.

Here, the upper limit of the number of cards in the hand is set to 9 for each player, and thus a player that already has 9 cards in the hand cannot add cards to the hand unless the number of cards held in the hand decreases to 8 or less.

The turn player can evolve an evolvable follower card 202 among the player's own follower cards 202 on the field as long as the evolution is within the range of the play points given.

In particular, a player can evolve a follower card 202 by drawing, from the player's own evolution deck 224, an evolution card 204 corresponding to the evolvable follower card 202 on the field and then placing this evolution card 204 on top of the evolvable follower card 202 on the field. In the example illustrated in FIG. 5, an evolution card 204 is placed on top of the leftmost follower card 202 on the field.

When an evolution card 204 is placed on the field, the evolution cost indicated in the evolved follower card 202 is subtracted from the play points, and when the play points reach 0, other evolvable follower cards 202 cannot be evolved and cards with costs indicated therein can no longer be placed on the field on this turn.

However, in this embodiment, the first player has an advantageous element, and thus the second player can evolve an evolvable follower card 202 without consuming play points, but the second player can do this only once.

In addition, the turn player can attack the leader card 200 of the opponent or the follower card 202 or evolution card 204 of the opponent on the field by using, among the player's own follower cards 202 on the field, a follower card 202 that has been placed on the field on any of the earlier turns.

However, a follower card 202 that is newly placed on the field on the present turn cannot attack the leader card 200, the follower card 202, or the evolution card 204 of the opponent. In other words, the follower card 202 placed on the field on that turn basically cannot attack the leader card 200, the follower card 202, or the evolution card 204 of the opponent on the same turn.

However, an evolution card 204 on the field can attack the leader card 200, the follower card 202, or the evolution card 204 of the opponent even when the follower card 202 before evolution is placed on the field on the present turn.

Furthermore, the follower card 202 or evolution card 204 that attacked the leader card 200, the follower card 202, or the evolution card 204 of the opponent on the present turn cannot attack again on the present turn.

Each time an attack is made, the players subtract the attack power of the follower card 202 or evolution card 204 making the attack from the present physical strength of the leader card 200, the follower card 202, or the evolution card 204 subjected to the attack, and subtract the attack power of the follower card 202 or evolution card 204 subjected to the attack from the present physical strength of the follower card 202 or evolution card 204 making the attack.

In other words, when the attack target is a follower card 202 or an evolution card 204, both the attacker and the attack target have their present physical strength reduced; however, when the leader card 200 is the attack target, only the present physical strength of the leader card 200 is reduced since the leader card 200 is not capable of attacking.

In addition, the turn player can make its leader card 200 recover the physical strength by placing, onto the field, a player's own spell card 206 having an effect of recovering the physical strength of the leader card 200 or by satisfying the effect-generating conditions while the player's own amulet card 208 having an effect of recovering the physical strength of the leader card 200 is placed on the field.

The follower card 202 having a present physical strength of 0 or less is removed from the field, is placed face-up in a main graveyard area 226 on the side of the main deck 220 close to the player, and becomes non-usable. Furthermore, when the present physical strength of an evolution card 204 becomes 0 or less, the evolution card 204 having a present physical strength of 0 or less is removed from the field, is placed face-up in an evolution graveyard area 228 on the side of the evolution deck 224 close to the player, and becomes non-usable; in addition, a follower card 202 that corresponds to the evolution card 204 having a present physical strength of 0 or less is also removed from the field, is placed face-up in the main graveyard area 226, and becomes non-usable.

When the present physical strength of the leader card 200 becomes 0 or less, the player corresponding to the leader card 200 having a present physical strength of 0 or less loses, and the other player wins. Even when the present physical strength of the leader card 200 is not 0 or less, when there are zero cards remaining in the main deck 220, the player corresponding to the main deck 220 with zero remaining cards loses, and the other player wins.

As such, in this embodiment, the card game must proceed by alternating turns between the first player and the second player, in which the play points given to a player each time the turn comes are incrementally added, the play cost and the evolution cost are subtracted from the present play points, and, each time an attack is carried out, the attack power of the attacker card is subtracted from the present physical strength of the attacked card and the attack power of the card subjected to the attack is subtracted from the present physical strength of the attacker card. Thus, the players bear large burdens of administering various parameters.

Furthermore, when players play the card game of this embodiment face-to-face, the players can have fun playing the game through verbal communication; however, in the instances where verbal communication is not advisable, such as during epidemics, the players would be less eager to play face-to-face the card game of the present embodiment.

Thus, according to a program for assisting the card game of the present embodiment, as illustrated in FIG. 5, the players can administer the players' own present play points and the present physical strengths of the leader cards 200 of both players through smart phones beside the players so that the players can still have fun smoothly playing the game without verbal communication.

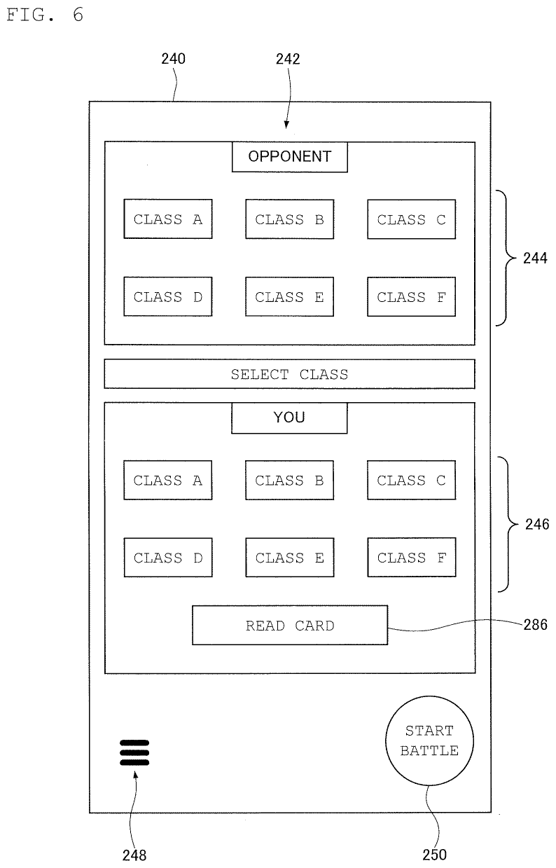

FIG. 6 is a diagram illustrating an example of images that are displayed in a display area 240 of a touch panel display of a smart phone according to the program for assisting the card game according to this embodiment. When the program of the present embodiment is activated, first, as illustrated in FIG. 6, a class input image 242 for inputting the class selected by the opponent and the class selected by the user player is displayed in the display area 240.

In the class input image 242, six first class input buttons 244 for inputting the class selected by the opponent are displayed in an upper portion of the display area 240, and six second class input buttons 246 for inputting the class selected by the user player are displayed in a center portion of the display area 240. A menu button 248 for displaying a menu image is displayed on the left side of the lower portion of the display area 240, and a battle start button 250 (progress indicator) corresponding to the start of battle is displayed on the right side of the lower portion of the display area 240.

When the menu button 248 is tapped, a menu image not illustrated in the drawing appears. In the menu image, the contact site of the card game of the present embodiment or the program for assisting the card game, and items for transitioning to the official website of the card game of the present embodiment are indicated.

When the battle start button 250 is tapped under the conditions that one of the first class input buttons 244 is tapped and selected and one of the second class input buttons 246 is tapped and selected in the class input image 242, the class corresponding to the selected second class input button 246 is set as the class selected by the user player.

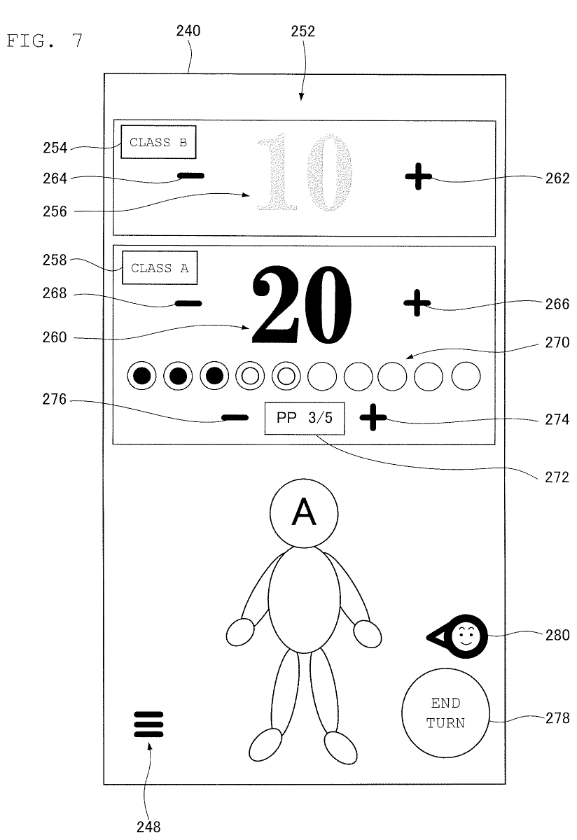

In addition, voice (narration voice) of the normal leader character of the class selected by the user player, the voice corresponding to the start of battle, is output from the speaker of the smart phone, and, as illustrated in FIG. 7, an administration image 252 for administering various parameters is displayed in the display area 240.

A first class indicator 254 that indicates the class corresponding to the first class input button 244 tapped in the class input image 242, that is, the class selected by the opponent, and a first leader physical strength indicator 256 that indicates the present physical strength of the leader card 200 of the opponent are displayed in the upper portion of the display area 240 in the administration image 252. In addition, a second class indicator 258 that indicates the class corresponding to the second class input button 246 tapped in the class input image 242, that is, the class selected by the user player, and a second leader physical strength indicator 260 that indicates the present physical strength of the leader card 200 of the user player are displayed in the center portion of the display area 240.

Each time a first plus button 262 on the right side of the first leader physical strength indicator 256 is tapped, the value of the first leader physical strength indicator 256 increases by 1, and each time a first minus button 264 on the left side of the first leader physical strength indicator 256 is tapped, the value of the first leader physical strength indicator 256 decreases by 1. Each time a second plus button 266 on the right side of the second leader physical strength indicator 260 is tapped, the value of the second leader physical strength indicator 260 increases by 1, and each time a second minus button 268 on the left side of the second leader physical strength indicator 260 is tapped, the value of the second leader physical strength indicator 260 decreases by 1.

Furthermore, a meter indicator 270 that indicates the initial play points on the present turn and the present play points in a form of a meter and a fraction indicator 272 that indicates the initial play points on the present turn and the present play points in a form of a fraction are displayed below the second leader physical strength indicator 260.

The meter indicator 270 indicates the initial play points of the present turn by the number of double circles found among ten horizontally lined-up circle marks, and indicates the present play points by the number of double circles with solid black circles inside.

In the example illustrated in FIG. 7, the number of double circles found among circle marks is 5, which indicates that the initial play points on the present turn are 5, and the number of double circles with solid black circles inside found among circle marks is 3, which indicates that the present play points are 3.

When one of the circle marks in the meter indicator 270 is tapped, the tapped circle mark and all of the double circles on the left of the tapped circle mark turn into double circles with solid black circles inside, and other circle marks turn into single circles or double circles with white circles inside. Furthermore, the value of the numerator of the fraction indicator 272 changes to the number of double circles with solid black circles inside, thereby changing the present play points.

When a third plus button 274 on the right side of the fraction indicator 272 is tapped, the value of the denominator in the fraction indicator 272 increases, and single circles sequentially turn into double circles with white circles inside starting from the left-most single circle so that the initial play points on the present turn increases. When a third minus button 276 on the left side of the fraction indicator 272 is tapped, the value of the denominator in the fraction indicator 272 decreases, and double circles with white circles inside sequentially turn into single circles starting from the right-most double circles with white circles inside so that the initial play points on the present turn decreases.

Furthermore, in the administration image 252, a normal leader character image corresponding to the picture on the normal leader card 200-1 of the class selected by the user player is displayed at the center of the lower portion of the display area 240. In addition, the menu button 248 is displayed on the left side of the lower portion of the display area 240, a turn end button 278 (progress indicator) corresponding to the end of turn is displayed on the right side of the lower portion of the display area 240, and a first emotion button 280 (emotion indicator) corresponding to emotional expression is displayed above the turn end button 278.

When the turn end button 278 is tapped, voice (narration voice) of the normal leader character of the class selected by the user player, the voice corresponding to the end of turn, is output from the speaker of the smart phone.

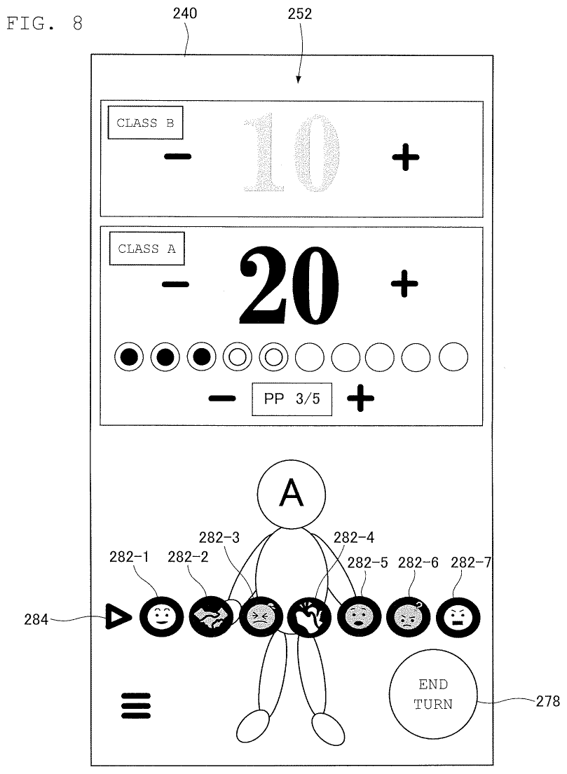

When the first emotion button 280 is tapped, as illustrated in FIG. 8, multiple types of second emotion buttons 282 (emotion indicator) corresponding to multiple types of emotional expression appear; however, when the first emotion button 280 is tapped in the administration image 252 where the normal leader character image is displayed, some of the second emotion buttons 282 appear grayed-out.

Specifically, the multiple types of second emotion buttons 282 that are displayed are a second emotion button 282-1 corresponding to greeting, a second emotion button 282-2 corresponding to gratitude, a second emotion button 282-3 corresponding to apology, a second emotion button 282-4 corresponding to praise, a second emotion button 282-5 corresponding to amazement, a second emotion button 282-6 corresponding to confusion, and a second emotion button 282-7 corresponding to provocation, and, when the first emotion button 280 is tapped in the administration image 252 in which the normal leader character image is displayed, the second emotion button 282-2 corresponding to gratitude, the second emotion button 282-3 corresponding to apology, the second emotion button 282-5 corresponding to amazement, and the second emotion button 282-6 corresponding to confusion appear grayed-out.

When the second emotion button 282-1 corresponding to greeting is tapped, the voice of the normal leader character of the class selected by the user player, the voice corresponding to greeting (voice of emotional expression), is output from the speaker of the smart phone; when the second emotion button 282-4 corresponding to praise is tapped, the voice of the normal leader character of the class selected by the user player, the voice corresponding to praise (voice of emotional expression), is output from the speaker of the smart phone; and when the second emotion button 282-7 corresponding to provocation is tapped, the voice of the normal leader character of the class selected by the user player, the voice corresponding to provocation (voice of emotional expression), is output from the speaker of the smart phone.

Meanwhile, the second emotion button 282-2 corresponding to gratitude, the second emotion button 282-3 corresponding to apology, the second emotion button 282-5 corresponding to amazement, and the second emotion button 282-6 corresponding to confusion that are grayed-out do not accept inputs even when tapped, and thus no sound corresponding to the emotional expression are output.

Note that the voice data corresponding to the start of battle, the voice data corresponding to the end of turn, the voice data corresponding to greeting, the voice data corresponding to praise, and the voice data corresponding to provocation of each normal leader character are downloaded when the program of this embodiment is downloaded.

When a back button 284 displayed on the left side of the second emotion button 282-1 corresponding to greeting is tapped, as illustrated in FIG. 7, the multiple types of second emotion buttons 282 are no longer displayed, and the first emotion button 280 is displayed.

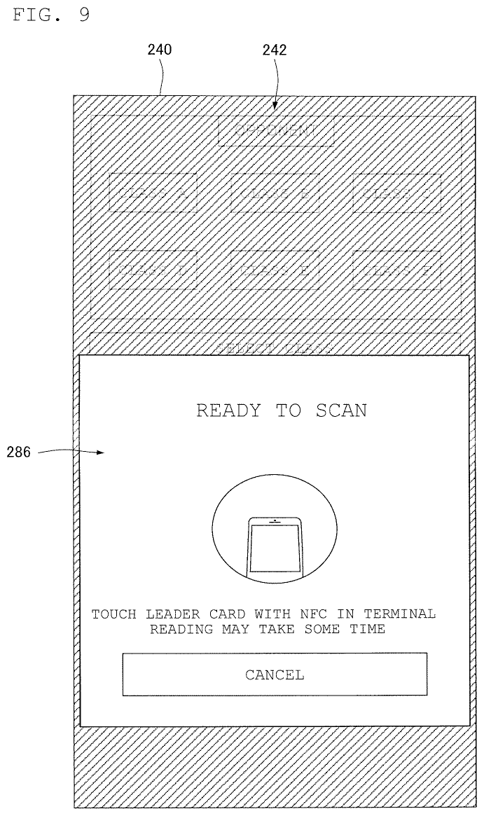

Moreover, in the class input image 242 illustrated in FIG. 6, a read button 286 for allowing the NFC reader of a smart phone to read the identification information of the aforementioned special leader card 200-2 is displayed below the six second class input buttons 246. When the read button 286 is tapped, as illustrated in FIG. 9, an instruction image 286 that instructs the player to bring the smart phone into contact with the special leader card 200-2 is displayed on the side of the class input image 242 close to the player, and the NFC reader starts reading.

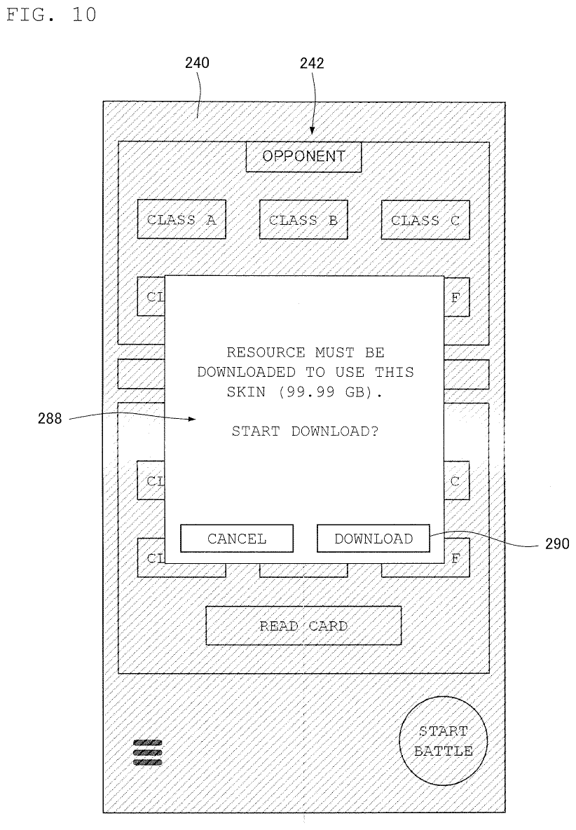

When the identification information of the special leader card 200-2 is read by the NFC reader of the smart phone, the class corresponding to the read identification information is set as the class selected by the user player. When the identification information of the read special leader card 200-2 is the information read for the first time, as illustrated in FIG. 10, a download permission image 288 for permitting download of data is displayed on top of the class input image 242.

Next, when a download button 290 is tapped, the read identification information of the special leader card 200-2 is sent to the server device 12, and, download of the data that corresponds to the read identification information of the special leader card 200-2 from among the data stored in the server information storage medium 20 in the server device 12 starts. In particular, the special leader character image corresponding to the picture on the special leader card 200-2 from which the identification information has been read, and the voice data of the special leader character corresponding to the read identification information are downloaded and stored in the terminal information storage medium 56.

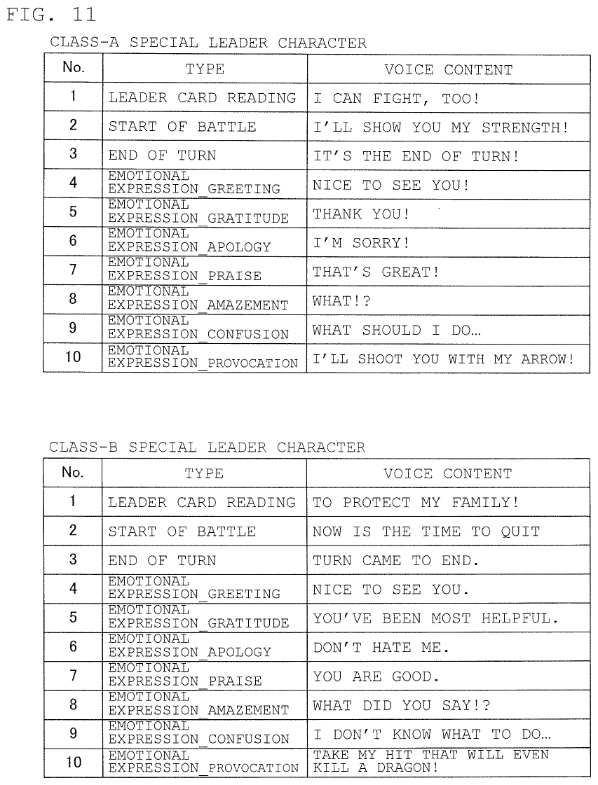

FIG. 11 includes tables showing the types of the voice data of the special leader character of each class and the contents of the voice. In this embodiment, one special leader character is available for each of Class A to Class F, and, as illustrated in FIG. 11, 10 types of voice data are prepared for the special leader character of each class.

Here, among the 10 types of voice data of the special leader character of each class illustrated in FIG. 11, the voice data No. 2 corresponding to the start of battle, the voice data No. 3 corresponding to the end of turn, the voice data No. 4 corresponding to greeting, the voice data No. 7 corresponding to praise, and the voice data No. 10corresponding to provocation have different voice contents from the voice data corresponding to the start of battle, the voice data corresponding to the end of turn, the voice data corresponding to greeting, the voice data corresponding to praise, and the voice data corresponding to provocation of the normal leader character. However, a normal leader character of each class and a special leader character of each class are recognized by the players as the same leader character; thus, the voice data of a normal leader character and the voice data of a special leader character of each class are the voice data created by the same voice actor or the same virtual voice actor (synthetic voice synthesized by a computer).

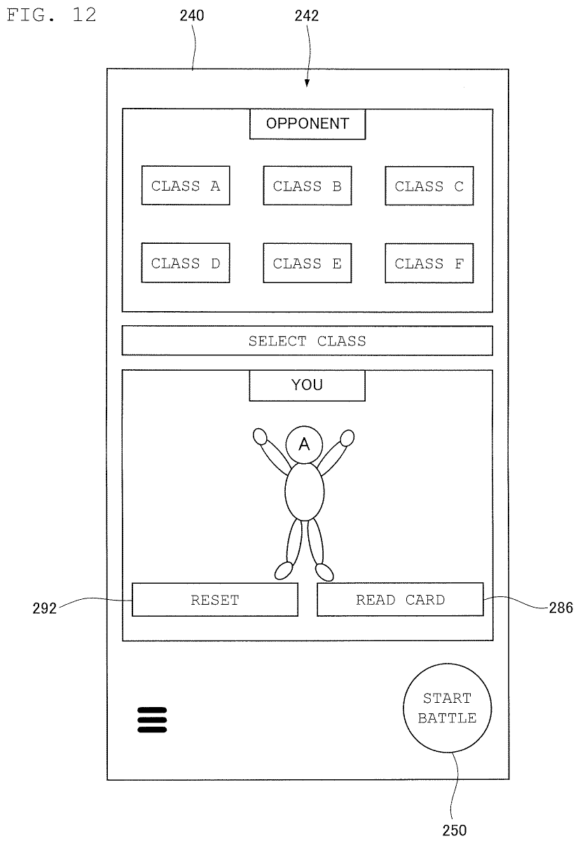

Upon completion of the download, as illustrated in FIG. 12, a class input image 242 that indicates the downloaded special leader character image, that is, the special leader character image corresponding to the read identification information, the read button 286, and a reset button 292 is displayed instead of the second class input buttons 246 in the class input image 242 illustrated in FIG. 6; in addition, the voice of the special leader character corresponding to the read identification information, the voice corresponding to the leader card reading, is output from the speaker of a smart phone.

Meanwhile, when the identification information of the read special leader card 200-2 is not the information read for the first time, that is, when the data corresponding to the identification information of the read special leader card 200-2 has already been downloaded, the download permission image 288 illustrated in FIG. 10 is not displayed, and a class input image 242 indicating the special leader character image corresponding to the read identification information illustrated in FIG. 12 is displayed. In addition, the voice of the special leader character corresponding to the read identification information, the voice corresponding to the leader card reading, is output from the speaker of a smart phone.

When the read button 286 is tapped, the instruction image 286 illustrated in FIG. 9 is again displayed, and the NFC reader starts reading. Meanwhile, when the reset button 292 is tapped, the class input image 242 indicating the second class input buttons 246 illustrated in FIG. 6 is displayed.

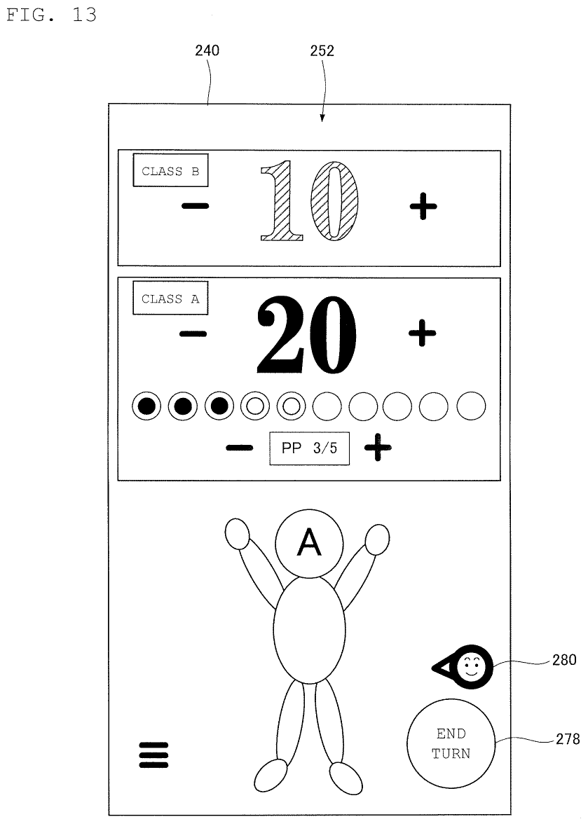

Meanwhile, when the battle start button 250 in the class input image 242 indicating the special leader character image illustrated in FIG. 12 is tapped, the voice of the special leader character corresponding to the read identification information, the voice corresponding to the start of battle, is output from the speaker of a smart phone, and, as illustrated in FIG. 13, the administration image 252 indicating the special leader character image is displayed in the display area 240 instead of the normal leader character image illustrated in FIG. 7.

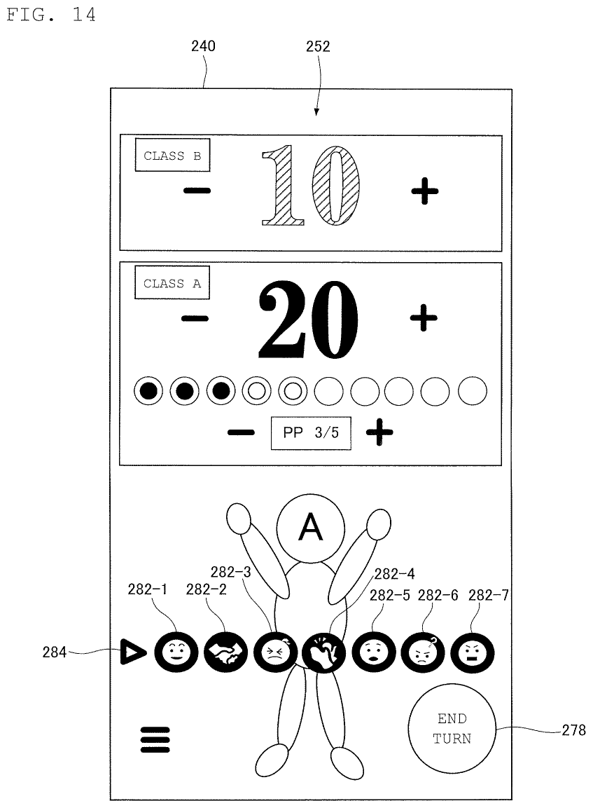

When the first emotion button 280 in the administration image 252 indicating the special leader character image is tapped, as illustrated in FIG. 14, all of the seven second emotion buttons 282 corresponding to the seven types of emotional expression are displayed without graying out.

Then, when the second emotion button 282-1 corresponding to greeting is tapped, the voice of the special leader character corresponding to the read identification information, the voice corresponding to greeting (voice of emotional expression), is output from the speaker of a smart phone; when the second emotion button 282-2 corresponding to gratitude is tapped, the voice of the special leader character corresponding to the read identification information, the voice corresponding to gratitude (voice of emotional expression), is output from the speaker of a smart phone; when the second emotion button 282-3 corresponding to apology is tapped, the voice of the special leader character corresponding to the read identification information, the voice corresponding to apology (voice of emotional expression), is output from the speaker of a smart phone; when the second emotion button 282-4 corresponding to praise is tapped, the voice of the special leader character corresponding to the read identification information, the voice corresponding to praise (voice of emotional expression), is output from the speaker of a smart phone; when the second emotion button 282-5 corresponding to amazement is tapped, the voice of the special leader character corresponding to the read identification information, the voice corresponding to amazement (voice of emotional expression), is output from the speaker of a smart phone; when the second emotion button 282-6 corresponding to confusion is tapped, the voice of the special leader character corresponding to the read identification information, the voice corresponding to confusion (voice of emotional expression), is output from the speaker of a smart phone; and when the second emotion button 282-7 corresponding to provocation is tapped, the voice of the special leader character corresponding to the read identification information, the voice corresponding to provocation (voice of emotional expression), is output from the speaker of a smart phone.

When the players wish to be assisted by the program of the present embodiment, the players activate the program of the present embodiment in their smart phones before starting the card game of the present embodiment. Then each player taps the first class input button 244 corresponding to the class selected by the opponent in the class input image 242 illustrated in FIG. 6 on the basis of the placed leader card 200 of the opponent, and taps the battle start button 250 while the second class input button 246 corresponding to the class selected by the user player is being tapped so as to allow the speaker of the smart phone of the player to output voice of a normal leader character of the class selected by the user player, the voice corresponding to the start of battle, and to display, in the display area 240 of the smart phone of each player, the administration image 252 indicating the normal leader character image illustrated in FIG. 7.

A player who owns a special leader card 200-2 taps the first class input button 244 corresponding to the class selected by the opponent in the class input image 242 illustrated in FIG. 6, and taps the battle start button 250 in the class input image 242 illustrated in FIG. 12 while the identification information of the special leader card 200-2 is read so as to allow the speaker of the smart phone of the player to output a voice of the special leader character corresponding to the read identification information, the voice corresponding to the start of battle, and to display, in the display area 240 of the smart phone, the administration image 252 indicating the special leader character image illustrated in FIG. 13.

Each player taps the first plus button 262 or the first minus button 264 in the administration image 252 illustrated in FIG. 7 on the basis of the initial physical strength indicator 210 of the placed leader card 200 of the opponent so that the initial physical strength of the leader card 200 of the opponent is displayed in the first leader physical strength indicator 256, and taps the second plus button 266 or the second minus button 268 in the administration image 252 on the basis of the initial physical strength indicator 210 of the placed player's own leader card 200 so that the initial physical strength of the player's own leader card 200 is displayed in the second leader physical strength indicator 260.

When the card game of this embodiment is in progress, the player who attacked the leader card 200 of the opponent taps the first minus button 264 in the administration image 252 on the basis of the attack power indicator 212 of the attacker card so that the present physical strength of the opponent's leader card 200 is indicated in the first leader physical strength indicator 256.

When the player had its leader card 200 attacked, the player taps the second minus button 268 in the administration image 252 on the basis of the attack power indicator 212 of the attacker card so that the present physical strength of the player's own leader card 200 is indicated in the second leader physical strength indicator 260.

The player who performed recovery of the physical strength of the player's own leader card 200 taps the second plus button 266 in the administration image 252 on the basis of the recovery power of the card from which the recovery effect has been generated so that the present physical strength of the player's own leader card 200 is indicated in the second leader physical strength indicator 260.

Furthermore, at every arrival of the turn, each player after tapping once the third plus button 274 in the administration image 252 taps the right-most double circle mark so that the initial play points of the present turn are indicated in the meter indicator 270 and the fraction indicator 272; here, on the 11th and subsequent turns, since 10 points are given as the initial play points, the player does this without tapping the third plus button 274.

In addition, each player taps the third minus button 276 in the administration image 252 on the basis of the consumed play points every time play points are consumed so that the present play points on the present turn are indicated in the meter indicator 270 and the fraction indicator 272.

In addition, each player at the end of its turn taps the turn end button 278 in the administration image 252 so that the voice of the normal leader character of the class selected by the player or the voice of the special leader character corresponding to the read identification information, the voice corresponding to the end of turn, is output from the speaker of the player's smart phone.

In addition, each player, at a desired timing, taps the first emotion button 280 in the administration image 252 and taps any desired second emotion button 282 so that the voice of the normal leader character of the class selected by the player or the voice of the special leader character corresponding to the read identification information, the voice corresponding to the desired emotional expression, is output from the speaker of the player's smart phone.

As such, in this embodiment, the players' burden to administer various parameters is alleviated, and the players can have fun playing the game smoothly without verbal communication; thus, even in the situation where verbal communication is not advisable, such as during epidemics, the players would be more eager to play face-to-face the card game of the present embodiment.

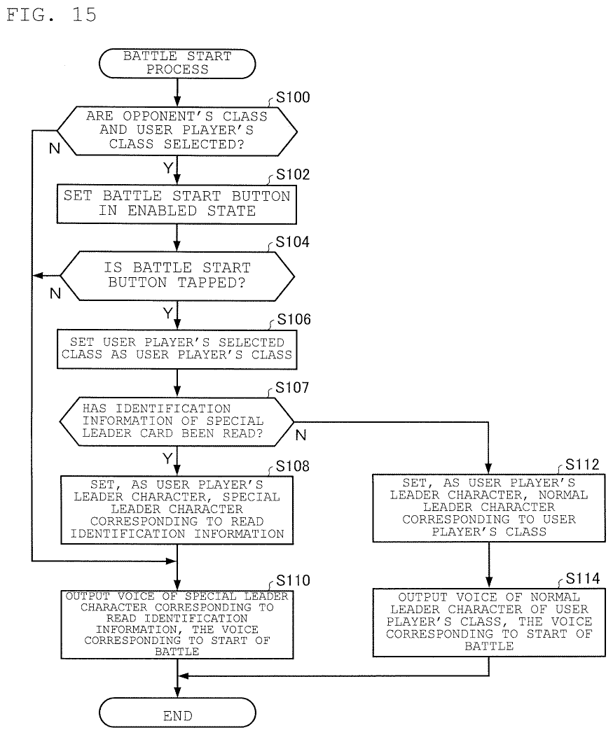

Hereinafter, the flow of the process executed in the terminal device 14 of this embodiment is described by using the flowcharts illustrated in FIGS. 15 to 17.

In the battle start process illustrated in FIG. 15, the input accepting unit 101 judges whether or not the class of the opponent and the class of the user player are being selected on the basis of whether one of the first class input buttons 244 and one of the second class input buttons 246 are being selected or whether one of the first class input buttons 244 is being selected and the identification information of the special leader card 200-2 is read (step S100). When the class of the opponent and the class of the user player are being selected (Y in step S100), the input accepting unit 101 sets the battle start button 250 to an enabled state (step S102).

Next, the input accepting unit 101 judges whether or not the battle start button 250 has been tapped (step S104), and, if the battle start button 250 has been tapped (Y in step S104), the setting unit 102 sets, as the class of the user player, the class selected by the user player (step S106).

Then the setting unit 102 judges whether or not the identification information of the special leader card 200-2 has been read (step S107). When the identification information of the special leader card 200-2 has been read (Y in step S107), a special leader character corresponding to the read identification information is set as the leader character of the user player (step S108).

Then the sound control unit 106 commands the sound output unit 54 to output the voice of the special leader character corresponding to the read identification information, the voice corresponding to the start of battle (step S110).

Meanwhile, if the identification information of the special leader card 200-2 has not been read (N in step S107), a normal leader character of the player's own class is set as the leader character of the user player (step S112).

Then the sound control unit 106 commands the sound output unit 54 to output the voice of the normal leader character of the player's own class, the voice corresponding to the start of battle (step S114).

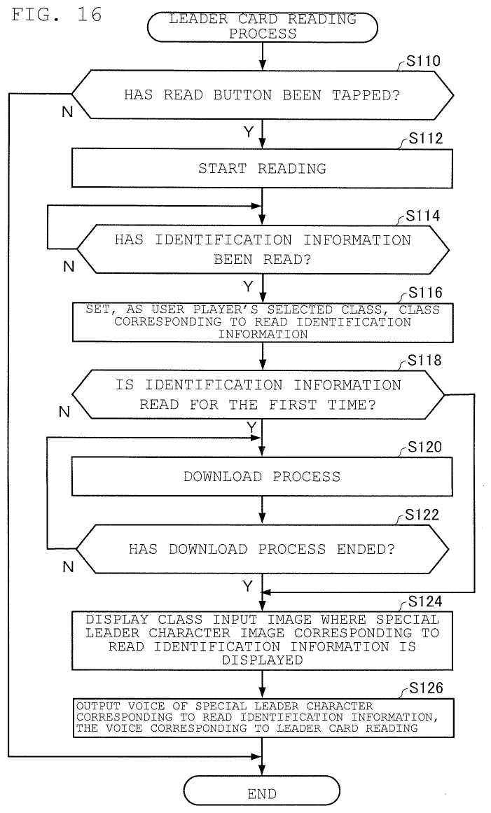

In the leader card reading process illustrated in FIG. 16, the input accepting unit 101 judges whether or not the read button 286 has been tapped (step S110), and when the read button 286 has been tapped (Y in step S110), the specific information acquisition unit 103 commands the NFC reader to start reading the identification information of the special leader card 200-2 (step S112).

When the NFC reader reads the identification information and thus the specific information acquisition unit 103 acquires the identification information of the special leader card 200-2 (Y in step S114), the setting unit 102 sets, as the class selected by the user player, the class corresponding to the read identification information (step S116).

Then the specific information acquisition unit 103 judges whether or not the read identification information is the identification information read for the first time (step S118), and if the read identification information is the identification information read for the first time (Y in step S118), the terminal communication control unit 112 performs a download process (step S120).

Upon completion of the download process (Y in step S122), the display control unit 104 commands the display unit 52 to display the class input image 242 indicating the special leader character image corresponding to the read identification information (step S124), and the sound control unit 106 commands the sound output unit 54 to output the voice of the special leader character corresponding to the read identification information, the voice corresponding to leader card reading (step S126).

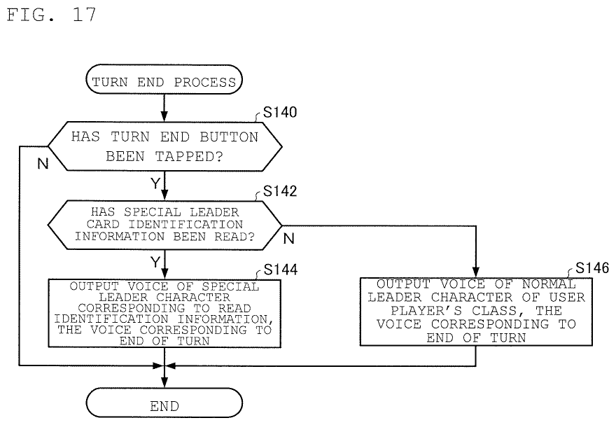

In the turn end process illustrated in FIG. 17, the input accepting unit 101 judges whether or not the turn end button 278 has been tapped (step S140). If the turn end button 278 has been tapped (Y in step S140), the setting unit 102 judges whether or not the identification information of the special leader card 200-2 is read (step S142), and when the identification information of the special leader card 200-2 is read (Y in step S107), the sound control unit 106 commands the sound output unit 54 to output the voice of the special leader character corresponding to the read identification information, the voice corresponding to the end of turn (step S144).

Meanwhile, when the identification information of the special leader card 200-2 has not been read (N in step S142), the sound control unit 106 commands the sound output unit 54 to output the voice of the normal leader character of the player's own class, the voice corresponding to the end of turn (step S146).

### 3. Modification Examples

The present invention is not limited to those features described in the aforementioned embodiments and is subject to various modifications, examples of which are described below. Note that the aforementioned embodiments and various features described as modification examples below can be combined as appropriate and implemented as features that implement the present invention.

First, in the aforementioned embodiments, the case in which the normal leader card 200-1 is not equipped with an NFC tag 211 is described as an example; alternatively, the normal leader card 200-1 may also be equipped with an NFC tag 211. In this case, modification may be made such that, when the identification information (specific information) of the normal leader card 200-1 is read, the voice data of the normal leader character corresponding to the second emotion button 282 grayed-out in the administration image 252 illustrated in FIG. 8 may be downloaded and stored in the terminal information storage medium 56.

Specifically, modifications may be made such that, of the 10 types of voice data of each normal leader character, 5 types of voice data, that is, No. 2: start of battle, No. 3:end of turn, No. 4: greeting, No. 7: praise, and No. 10: provocation, may be downloaded together with the normal leader character image when the program of the present embodiment is downloaded, but other 5 types of voice data, that is, No. 1: leader card reading, No. 5: gratitude, No. 6: apology, No. 8: amazement, and No. 9: confusion, may be not downloaded when the program of the present embodiment is downloaded but may be downloaded under the condition that the identification information of the normal leader card 200-1 is read.

In this case, the voice data No. 1: leader card reading, No. 5: gratitude, No. 6:apology, No. 8: amazement, and No. 9: confusion of the normal leader character may have different voice contents from those of the voice data No. 1: leader card reading, No. 5: gratitude, No. 6: apology, No. 8: amazement, and No. 9: confusion of the special leader character.

Alternatively, one leader character may be linked to one class, or two or more leader characters may be linked to one class. Even when two or more leader characters are linked to one class, there may be a normal leader card 200-1 and a special leader card 200-2 for each leader character of one class. In such a case, after selecting one class, the player may select one leader character from the two or more leader characters of that class.

Furthermore, there are a normal leader card 200-1 and a special leader card 200-2 for one leader character of one class; however, there may be no normal leader card 200-1 but only a special leader card 200-2 for a leader character of other classes. In such a case, when the identification information of a special leader card 200-2 is read, the special leader character image may be displayed and the voice corresponding to the special leader character may be output.

That is, modifications may be made such that multiple types of special leader characters are linked to one class, and different special leader character images are displayed and different sets of special leader character voice may be output for each special leader character.

Moreover, in the aforementioned embodiments, the case where the player selects a class in the class input image 242, as a result of which a normal leader character image corresponding to the class selected by the user player is displayed and the voice of the normal leader character of the class selected by the user player, is described as an example; alternatively, modifications may be made such that the player selects one leader character from multiple types of leader characters, as a result of which a normal leader character image corresponding to the leader character selected by the user player is displayed and the voice of the normal leader character of the class selected by the user player is output.

In the aforementioned embodiments, the case in which the second emotion buttons 282 not outputting voice are grayed out and displayed when the first emotion button 280 in the administration image 252 indicating the normal leader character image is tapped is described as an example; alternatively, the second emotion buttons 282 that do not output any voice may be completely undisplayed.

In the aforementioned embodiments, the case in which each player manually inputs the initial physical strength to be indicated in the first leader physical strength indicator 256 and the second leader physical strength indicator 260 is described as an example; alternatively, the initial physical strength to be indicated in the first leader physical strength indicator 256 and the second leader physical strength indicator 260 may be automatically displayed on the basis of the type of the class or the type of the leader character selected by the player.

In the aforementioned embodiment, the case in which each player manually inputs the initial play points of the present turn to the meter indicator 270 and the fraction indicator 272 is described as an example; alternatively, the initial play points of the next turn may be automatically indicated in the meter indicator 270 and the fraction indicator 272 by tapping the turn end button 278.

In the aforementioned embodiments, the case in which the first leader physical strength indicator 256, the second leader physical strength indicator 260, the meter indicator 270, and the fraction indicator 272 are indicated in the administration image 252 is described as an example. Alternatively, the indicators for administering other parameters common to all classes, such as the number of turn, the number of times evolution occurred, the remaining number of times evolution can occur, the remaining evolution points needed for evolution, the physical strength of the follower card or evolution card on the field, etc., may be displayed in a changeable manner, or the indicators of the parameters of abilities specific to a specific class or the indicators for administering abilities specific to a specific card of a specific class may be displayed in a changeable manner. An indicator for administering a parameter of an ability specific to a specific class may be displayed when the specific class is selected but not when other classes are selected. An indicator for administering a parameter of an ability specific to a specific card of a specific class may be displayed when the specific card of the specific class is included in the main deck 220 and when the player performs an input or the identification information of the specific card is read, but not under any other conditions.

In the embodiment described above, the case in which the NFC tag 211 of the special leader card 200-2 is read by an NFC reader is described as an example; alternatively, the identification information of the normal leader card 200-1 or the special leader card 200-2 may be acquired by reading a two-dimensional code printed on the normal leader card 200-1 or the special leader card 200-2 with a camera.

In the embodiment described above, the case in which the follower card 202 can be evolved by consuming play points is described as an example; alternatively, the number of times the follower card 202 can evolve regardless of the play points may be set. In such a case, the number of times the follower card 202 can evolve may be set to 2for the first player and 3 for the second player.

In the aforementioned embodiments, the case in which the present invention is applied to a game application of a smart phone is described as an example; alternatively, the present invention may be applied to a gaming machine (information processing device) installed in a store or to a home gaming machine (information processing device). When the present invention is applied to a gaming machine installed in a store or a gaming machine for home, the terminal device may serve as a gaming device, and multiple gaming devices may communicate with the server device and with one another, and, in such a case, the present invention can be applied to the gaming devices and server devices. Alternatively, the present invention may be applied to a stand-alone gaming device not connected to the server device 12.

What is claimed is:

1. A program for assisting a game in which players play a battle against each other using real game media, the program instructing a computer to function as:
a display control unit that commands a display unit to display a progress indicator corresponding to the progress of the game,
an input accepting unit that accepts an input, by a player, corresponding to the progress indicator,
a sound control unit that commands a sound output unit to output narration voice related to the progress of the game when the input, by the player, corresponding to the progress indicator is accepted, and
a setting unit that sets, on the basis of the input by the player, one of a plurality of types of characters as the character linked to the player,
wherein the sound control unit
commands the sound output unit to output the narration voice corresponding to the character set as linked to the player.

2. The program according to claim 1, the program further instructing the computer to function as:
a specific information acquisition unit that acquires specific information corresponding to the real game media,
wherein the sound control unit
commands the sound output unit to output the narration voice corresponding to the acquired specific information.

3. The program according to claim 1,
wherein the display control unit
commands the display unit to display a plurality of types of emotion indicators corresponding to a plurality of types of emotional expression,
the input accepting unit
accepts an input, by a player, corresponding to one of the plurality of types of emotion indicators, and
when the input, by the player, corresponding to one of the plurality of types of emotion indicators is accepted, the sound control unit
commands the sound output unit to output voice of emotional expression corresponding to the emotion indicator input by the player.

4. A program for assisting a game in which players play a battle against each other using real game media, the program instructing a computer to function as:
a display control unit that commands a display unit to display a plurality of types of emotion indicators corresponding to a plurality of types of emotional expression,
an input accepting unit that accepts an input, by a player, corresponding to one of the plurality of types of emotion indicators, and
a sound control unit that commands a sound output unit to output voice of the emotional expression corresponding to the emotion indicator input by the player when the input, by the player, corresponding to one of the plurality of types of emotion indicators is accepted.

5. The program according to claim 1,
wherein the display control unit
commands the display unit to display a parameter indicator indicating a parameter of the game and causes the parameter indicator to change on the basis of an input by a player.

6. An information processing device that assists a game in which players play a battle against each other using real game media, the information processing device comprising:
a display control unit that commands a display unit to display a progress indicator corresponding to the progress of the game;
an input accepting unit that accepts an input, by a player, corresponding to the progress indicator;
a sound control unit that commands a sound output unit to output narration voice related to the progress of the game when the input, by the player, corresponding to the progress indicator is accepted; and
a setting unit that sets, on the basis of the input by the player, one of a plurality of types of characters as the character linked to the player,
wherein the sound control unit
commands the sound output unit to output the narration voice corresponding to the character set as linked to the player.

7. An information processing method for assisting a game in which players play a battle against each other using real game media, the information processing method executable by a computer and comprising:
setting, on the basis of an input by a player, one of a plurality of types of characters as the character linked to the player;
commanding a display unit to display a progress indicator corresponding to the progress of the game;
accepting an input, by a player, corresponding to the progress indicator; and
commanding a sound output unit to output narration voice that corresponds to the character set as linked to the player and that is related to the progress of the game.

8. An information processing device that assists a game in which players play a battle against each other using real game media, the information processing device comprising:
a display control unit that commands a display unit to display a plurality of types of emotion indicators corresponding to a plurality of types of emotional expression;
an input accepting unit that accepts an input, by a player, corresponding to one of the plurality of types of emotion indicators, and
a sound control unit that commands a sound output unit to output voice of the emotional expression corresponding to the emotion indicator input by the player when the input, by the player, corresponding to one of the plurality of types of emotion indicators is accepted.

9. An information processing method for assisting a game in which players play a battle against each other using real game media, the information processing method executable by a computer and comprising:
commanding a display unit to display a plurality of types of emotion indicators corresponding to a plurality of types of emotional expression;
accepting an input, by a player, corresponding to one of the plurality of types of emotion indicators; and
commanding a sound output unit to output voice of the emotional expression corresponding to the emotion indicator input by the player when the input, by the player, corresponding to one of the plurality of types of emotion indicators is accepted.
